(19) United States
(12) Patent Application Publication
(10) Pub. No.: US 2005/0264026 A1
(43) Pub. Date: Dec. 1, 2005

(54) Hail hunter

(76) Inventor: Ronald John Badamo, Lubbock, TX (US)

Correspondence Address: RONALD BADAMO, 6001 W. 34TH STREET SPACE 53, LUBBOCK, TX, 79407, US

(21) Appl. No.: 10/666,762

(22) Filed: May 28, 2004

(51) Int. Cl. B60J 11/00

(52) U.S. Cl. 296/136.02

(57) ABSTRACT

The Hail Hunter is a thick vehicle cover designed to protect vehicles against hail damage. The cover The cover is six inches thick of vinyl which is made to order to fit your vehicle. The cover is simply placed over the vehicle for protection. The adjustable straps are fastened to hold the cover into place. Can easily be cleaned with soap and water and is very durable. Thickness for protection is a new concept based on the older thin car covers. Thicker car covers for better car protection.

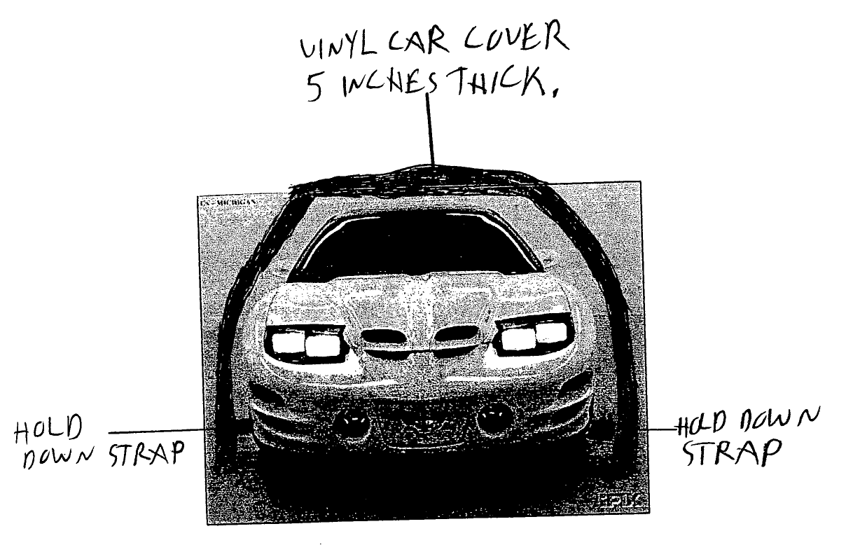

The Hail Hunter is a thick vehicle cover designed to protect vehicles against hail damage.

The cover is five to six inches thick of vinyl. The cover which is made to order to fit your vehicle is simply placed over the vehicle. The straps are fastened to hold the cover into place. Can easily be cleaned with soap and water and is very durable.

I have not seen any cover being sold that offers Hail Damage Protection. The covers being sold today are just too thin to offer Hail Damage Protection.

1. What I claim as my invention is The Hail Hunter. The Hail Hunter is thicker then the other car covers being sold today offering hail protection. I have not seenany car cover being sold that offers hail protection. The covers today are just too thin to offer hail damage protection. This is why I feel that I'm the inventer of this improved car cover.
